(19) United States
(12) Patent Application Publication
(10) Pub. No.: US 2025/0125443 A1
(43) Pub. Date: Apr. 17, 2025

(54) BATTERY SYSTEM

(71) Applicant: Purem GmbH, Neunkirchen (DE)

(72) Inventors: Felix Neumann, Aichwald (DE); Dennis Felger, Esslingen (DE); Benedikt Klein, Neunkirchen (DE); Michael Mayer, Bempflingen (DE)

(21) Appl. No.: 18/918,233

(22) Filed: Oct. 17, 2024

(30) Foreign Application Priority Data
Oct. 17, 2023 (DE) 10 2023 128 339.1

(51) Int. Cl. H01M 10/6563; H01M 10/48; H01M 10/613; H01M 10/615; H01M 10/625; H01M 10/63; H01M 50/249

(52) U.S. Cl. CPC H01M 10/6563; H01M 10/486; H01M 10/613; H01M 10/615; H01M 10/625; H01M 10/63; H01M 50/249

(57) ABSTRACT

A battery system, in particular for a vehicle, includes a battery system housing, wherein the battery system housing has an air inlet region and an air outlet region for the air flowing through the battery system housing and at least one battery unit. The at least one battery unit is accommodated in the battery system housing so that air flowing through the battery system housing can flow around the at least one battery unit.

### CROSS-REFERENCE TO RELATED APPLICATIONS

This application claims priority of German patent application no. 10 2023 128 339.1, filed Oct. 17, 2023, the entire content of which is incorporated herein by reference.

### TECHNICAL FIELD

The present disclosure relates to a battery system which can be used, for example, in vehicles powered by an electric motor. Such a battery system can also be applied in other fields of use such as, for example, in conjunction with stationary photovoltaic installations or the like.

### BACKGROUND

Such battery systems generally include battery units which have relatively large dimensions and are configured to store large amounts of energy and to generate relatively high operating currents. It is advantageous to operate such battery units within a predetermined temperature range for efficient operation and to avoid damage.

### SUMMARY

An object of the present disclosure is to supply a battery system, for example for use in vehicles powered by an electric motor, with which the temperature of a battery unit can be set and regulated in a simple manner.

According to the disclosure, this object is achieved by a battery system, in particular for a vehicle, including:
a battery system housing, wherein the battery system housing has an air inlet region and an air outlet region for the air flowing through the battery system housing,
at least one battery unit, wherein the at least one battery unit is accommodated in the battery system housing so that air flowing through the battery system housing can flow around it.

In this battery system, in contrast to what is generally usual in electrically powered vehicles, a gas, namely air, is used as the temperature-control medium. This results in a significantly simplified structure for the components guiding the temperature-control medium and enables a relatively quick reaction to changes in temperature.

In order to be able to set the supply of air simply in a defined fashion, it is proposed that a first shut-off device is associated with the air inlet region in order selectively to shut off the air inlet region against the inlet of air into the battery system housing and to free the air inlet region for the inlet of air into the battery system housing. Likewise, in order to set the discharge of air in a defined fashion, a second shut-off device can be associated with the air outlet region in order selectively to shut off the air outlet region against the outlet of air from the battery system housing and to free the air outlet region for the outlet of air from the battery system housing.

An air delivery device for delivering air through the battery system housing can be provided in order to generate a flow of air.

For an efficient delivery mode, it is advantageous if the air delivery device is provided at the air inlet region or upstream from the air inlet region.

In order to supply heat to the air which is to be used for the thermal conditioning of the at least one battery unit in order to heat the at least one battery unit, a heating device can be provided for heating air flowing through the battery system housing.

The heating device is advantageously provided at the air inlet region or upstream from the air inlet region.

The heating device can be provided, for example, upstream from the air delivery device or/and downstream from the first shut-off device.

For increased efficiency in the thermal conditioning, the at least one battery unit can include a plurality of battery cells arranged spaced apart from one another in the battery system housing.

In order to be able to supply a system which works essentially autonomously, it is proposed that at least one device including a first shut-off device, a second shut-off device, an air delivery device, and a heating device is fed with electrical energy from the at least one battery unit. It is then not necessary to supply a further energy store for operating such a system region.

### BRIEF DESCRIPTION OF DRAWINGS

The invention will now be described with reference to the drawings wherein:

FIG. 1 shows an illustration in principle of a battery system in a battery heating mode;

FIG. 2 shows the battery system of FIG. 1 in a battery cooling mode; and,

FIG. 3 shows the battery system of FIG. 1 in a battery insulating mode.

### DETAILED DESCRIPTION

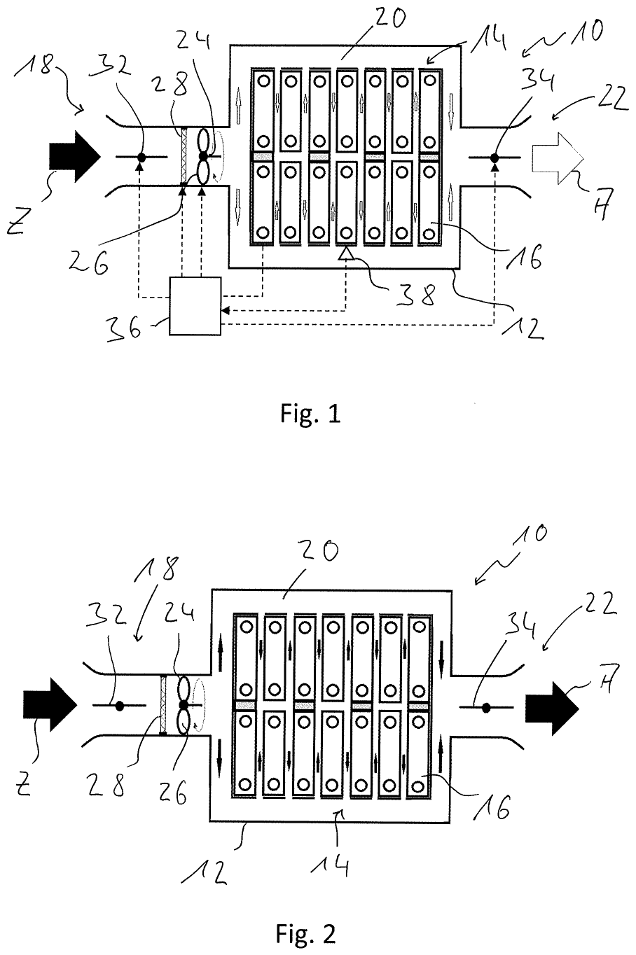

FIG. 1 shows an illustration in principle of a battery system 10 which can be used, for example, in a vehicle powered by an electric motor in order to feed the drive motors with electrical energy. The battery system 10 includes a battery system housing 12, constructed for example with plastic material or/and metal material, in which is arranged a battery unit designated generally by 14. The battery unit 14 can include a plurality of battery cells 16 arranged at least partially spaced apart from one another.

The battery system housing 12 has an air inlet region 18 which has a duct-like configuration in the embodiment illustrated and via which ambient air present in the region of the battery system 10 can enter an interior 20 of the battery system housing 12 as supply air Z. The battery system housing 12 likewise includes an air outlet region 22 which also has a duct-like configuration in the embodiment illustrated and via which the air flowing through the interior 20 of the battery system housing 12 can be discharged to the surroundings as exhaust air A.

In the air inlet region 18 which has a duct-like configuration, an air delivery device 24 configured, for example, as a fan, compressor, or the like is provided with an impeller 26 which can be driven in rotation in order to deliver the supply air Z into the interior 20 of the battery system housing 12. Under the delivery action of the air delivery device 24, the supply air Z flows into the interior 20 and, as indicated by flow arrows, flows along the outer surface of the battery unit 14 or also between the battery cells 16, arranged spaced apart from one another, of the battery unit 14. After the air has flowed around the battery unit 14, the exhaust air A leaves the interior 20 via the air outlet region 22.

A heating device 28 is arranged upstream from the air delivery device 24 in the duct-like air inlet region 18. In the embodiment illustrated, the heating device 28 is electrically powered and includes, for example, one or more heating conductors generating heat when an electrical voltage is applied. The supply air Z which is delivered through the air inlet region 18 by the impeller 26 of the air delivery device 24 and has essentially the ambient temperature before it enters the air inlet region 18 absorbs heat in the region of the heating device 28 and thus enters the interior 20 of the battery system housing 12 in heated form. When the air flows around the battery unit 14, the supply air Z transmits heat to the battery unit 14 and thus leaves the interior 20 of the battery system housing 12 as exhaust air A with a temperature which is reduced in comparison with the temperature of the supply air Z heated at the heating device 28.

In order to free the battery system housing 12 so that air can flow through it as a temperature-control medium, a first shut-off device 32 arranged, for example, likewise in the duct-like air inlet region 18 upstream from the heating device 28 is associated with the air inlet region 18. The first shut-off device 32 can be configured in the manner of a valve or a throttle flap used, for example, in exhaust systems and can be adjusted by an associated actuator between a closed position essentially shutting off the air inlet region 18 against the inlet of air and the open position illustrated in FIG. 1 essentially freeing the air inlet region 18 for air to flow through it.

A second shut-off device 34 arranged, for example, in the duct-like air outlet region 22 is associated with the air outlet region 22. This too can be configured in the manner of a valve or a flap and can be adjusted by an associated actuator between the open position illustrated in FIG. 1 and freeing the air outlet region 22 for air to flow through it and a closed position essentially shutting off the air inlet region 22 against the passage of air.

The air delivery device 24, the heating device 28, and the two shut-off devices 32, 34 are activated by a control unit 36. The latter can, for example by taking into account a temperature signal output by a temperature sensor 38, activate the different system regions activated by it in accordance with the temperature status of the battery unit 14. If the temperature signal output by the temperature sensor 38 indicates that the temperature of the battery unit 14 is too low, the control unit 36 can, in the battery heating mode illustrated in FIG. 1, activate the two shut-off devices 32, 34 such that the latter are in or are moved into their open position. Moreover, the control unit 36 activates the air delivery device 24 in order to deliver the supply air Z via the air inlet region 18 into the interior 20 of the battery system housing 12 and activates the heating device 28 in order to generate heat to heat the supply air Z. As illustrated in FIG. 1, the control unit 36 can here take the electrical energy required to operate the various system regions from the battery unit 14, for example from a battery cell 16 of the battery unit 14, such that the battery system 10 can be operated essentially autonomously in terms of the energy requirement.

In the battery heating mode, the degree of heating of the battery unit 14 can be set, on the one hand, by setting the delivered amount of supply air Z and, on the other hand, by the amount of heat generated in the heating device 28. For this purpose, the speed of the impeller 26 and the heat output of the heating device 28 can be set by the control unit 36 in accordance with the heat requirement demanded.

FIG. 2 illustrates the battery system 10 in a battery cooling mode. In battery cooling mode, the supply air Z is delivered into the interior 20 of the battery system housing 12 with the shut-off devices 32, 34 placed in the open position and the heating device 28 not energized. For this purpose, the air delivery device 24 is operated by the control unit 36 (not illustrated in FIG. 2) in order to obtain a required volume flow of supply air. The supply air Z corresponding to the ambient temperature in terms of its temperature flows through the interior 20 and the battery cells 16, arranged therein, of the battery unit 14 and thus absorbs heat. When it leaves the battery system housing 12, the exhaust air A which is heated with respect to the supply air Z transports heat away from the battery unit 14 such that the latter is cooled and can be maintained in the optimal temperature range for the operation of the battery.

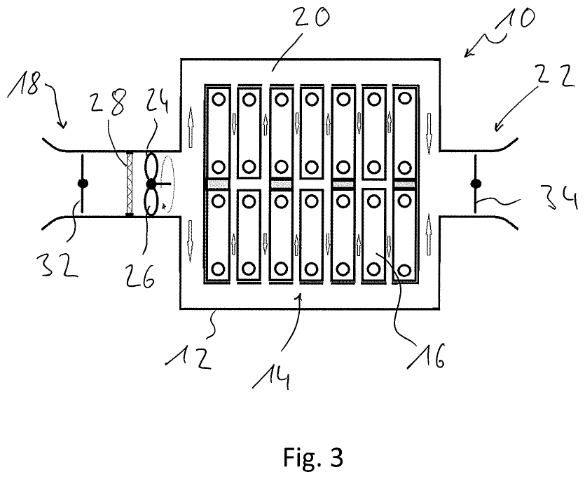

FIG. 3 shows the battery system 10 in a battery insulating mode. In battery insulating mode, the two shut-off devices 32, 34 are in their closed position such that essentially no supply air can flow into the interior 20 of the battery system housing 12 via the air inlet region 18 and essentially no exhaust air can escape from the interior 20 via the air outlet region 22. The heating device 18 is not operational in battery insulating mode and produces no heat. The air delivery device 24 can likewise be deactivated or can be operated to produce the circulation of air in the interior 20 of the battery system housing 12, for example with a relatively low speed of the impeller 26. Battery insulating mode is selected when the temperature of the battery unit 14, detected by the temperature sensor 38 illustrated in FIG. 1, lies within the optimal temperature range stipulated for its operation.

It should be noted that the battery system described above with reference to different types of operation and illustrated in the figures can be varied. Thus, for example, the energy required to operate the various system regions of the battery system can also be supplied by an external energy source, for example a low-voltage system in a vehicle. The control unit activating the various system regions can of course also be networked with an information system of a vehicle in order to set the operation of the battery system 10 to heat, cool, or maintain the temperature of the battery unit by taking further operating parameters of a vehicle into account. Furthermore, such a battery system can also be used in other applications, in particular stationary applications, for example in conjunction with a photovoltaic system provided on a building or in an open area.

It is understood that the foregoing description is that of the preferred embodiments of the invention and that various changes and modifications may be made thereto without departing from the spirit and scope of the invention as defined in the appended claims.

1. A battery system comprising:
a housing having an air inlet region and an air outlet region for accommodating air flowing through said housing; and,
a battery unit accommodated in said housing so as to permit air flowing through said housing to flow around said battery unit.

2. The battery system of claim 1, further comprising at least one of the following:
i) a first shut-off device associated with said air inlet region and being configured to selectively shut off said air inlet region with respect to an inlet of air into said housing and to clear said air inlet region for the inlet of air into said housing; and,
ii) a second shut-off device associated with said air outlet region and being configured to selectively shut off said air outlet region with respect to an outlet of air from said housing and to clear said air outlet region for the outlet of air from said housing.

3. The battery system of claim 1, further comprising an air delivery device for delivering air through said housing.

4. The battery system of claim 3, wherein said air delivery device is provided at said air inlet region or upstream from said air inlet region.

5. The battery system of claim 1, further comprising a heating device for heating air flowing through said housing.

6. The battery system of claim 5, wherein said heating device is provided at said air inlet region or upstream from said air inlet region.

7. The battery system of claim 6, wherein said heating device is provided upstream from said air delivery device.

8. The battery system of claim 6, wherein said heating device is provided downstream from said first shut-off device.

9. The battery system of claim 1, wherein said battery unit comprises a plurality of battery cells arranged spaced apart from one another in said housing.

10. The battery system of claim 1, further comprising:
an arrangement including:
a first shut-off device associated with said air inlet region;
a second shut-off device associated with said air outlet region;
an air delivery device for delivering air through said housing; and,
a heating device supplied with electrical energy from said battery unit.

11. The battery system of claim 1, wherein said battery system is for a vehicle.
